(19) United States
(12) Patent Application Publication
(10) Pub. No.: US 2021/0178260 A1
(43) Pub. Date: Jun. 17, 2021

(54) SIMULATIVELY-TOUCH METHOD, TOUCH CONTROL ASSEMBLY, AND TOUCH CONTROL SYSTEM

(71) Applicant: SHANGHAI FLYDIGI ELECTRONICS TECHNOLOGY CO., LTD., SHANGHAI (CN)

(72) Inventor: WEI HUANG, SHANGHAI (CN)

(21) Appl. No.: 16/768,707

(22) PCT Filed: Jan. 28, 2019
(86) PCT No.: PCT/CN2019/073521

§ 371 Date: Jun. 1, 2020

(30) Foreign Application Priority Data
Aug. 16, 2018 (CN) 201810935479.6
Aug. 16, 2018 (CN) 201810936474.5
Aug. 16, 2018 (CN) 201821325764.8

(51) Int. Cl. A63F 13/42; A63F 13/214; A63F 13/22; A63F 13/235

(52) U.S. Cl. CPC A63F 13/42; A63F 13/235; A63F 13/22; A63F 13/214

(57) ABSTRACT

The present disclosure is related to touch control technology. A simulatively-touch method, a touch control assembly, and a touch control system are provided. The simulatively-touch method is used for simulating a touch on a target device including a touch component and a touch panel connector. The method includes generating a non-touch event; converting the non-touch event into a touch event; and transmitting the touch event to the target device to simulate a touch performed on the touch component, wherein the touch event is transmitted to the touch panel connector in the target device.

### TECHNICAL HELD

The present disclosure generally relates to the technical field of touch control, and in particular, to a simulatively-touch method, a touch control assembly, and a touch control system.

### BACKGROUND

Currently, when a Bluetooth gaming device is used to manipulate a game of a terminal, it must acquire a specific authority from the terminal to achieve the manipulation function. This leads to complexity of an access and a control process of the game in the gaming device, and brings inconvenience of use of the gaming devices.

### SUMMARY OF THE DISCLOSURE

Embodiments of the present disclosure provides a simulatively-touch method, a touch control assembly, and a touch control system, for improving the convenience of use of touch control devices.

To solve the above-mentioned problem, one scheme adopted by present disclosure is to provide a simulatively-touch method, for simulating a touch on a target device including a touch component and a touch panel connector, including: generating a non-touch event; converting the non-touch event into a touch event; and transmitting the touch event to the target device to simulate a touch performed on the touch component, wherein the touch event is transmitted to the touch panel connector in the target device.

To solve the above-mentioned problem, another scheme adopted by the present disclosure is to provide touch control assembly for simulating a touch on a target device including a touch component and a touch panel connector, including a manipulation device, a conversion device, and a signal transmitter, the manipulation device and the signal transmitter being coupled to the conversion device, the manipulation device being configured for generating a non-touch event and transmitting the non-touch event to the conversion device; the conversion device being configured for receiving the non-touch event, converting the non-touch event into a touch event, and transmitting the touch event to the signal transmitter; the signal transmitter being configured for receiving the touch event from the processor, and transmitting the touch event to the target device so as to simulate a touch performed on the touch component; wherein the touch event is transmitted to the touch panel connector in the target device, and the touch control assembly is described as a human interface device (HID) of a touch control screen or a touch control panel for transmitting the touch event to the touch panel connector.

To solve the above-mentioned problem, another scheme adopted by the present disclosure is to provide touch control system, including a touch control assembly and a target device connected to the touch control assembly, the touch control assembly being configured for simulate a touch on the target device including a touch component and a touch panel connector, the touch control assembly including a manipulation device, a conversion device, and a signal transmitter, and the manipulation device and the signal transmitter being connected to the conversion device, respectively, the manipulation device including a physical button configured for generating a non-touch event and configured for transmitting the non-touch event to the conversion device; the conversion device being configured for receiving the non-touch event from the signal transmitter, converting the non-touch event into a touch event, and transmitting the touch event to the signal transmitter; the signal transmitter being configured for receiving the touch event from the processor, and transmitting the touch event to the target device so as to simulate a touch performed on the touch component; wherein the touch event is transmitted to the touch panel connector in the target device, and the touch control assembly is described as a human interface device (HID) of a touch control screen or a touch control panel for transmitting the touch event to the touch panel connector.

The implementation of the simulatively-touch method provided in the present disclosure can achieve a simulative touch on the touch component of a target device. The operation that the non-touch event is converted into the touch event is not performed in the target device, and this event conversion operation does not need specific authority from the target device. Thus, the operation of acquiring authority can be omitted, which simplifies the overall process of simulative touch control, and improves the convenience of use of gaming devices which adopt the simulatively-touch method provided by the present disclosure.

### BRIEF DESCRIPTION OF THE DRAWINGS

FIG. 1 shows a flow chart of a simulatively-touch method according to some embodiments of the present disclosure.

FIG. 2 is a schematic structural diagram of a target device according to some embodiments of the present disclosure.

FIG. 3 shows a flow chart of a simulatively-touch method according to another some embodiments of the present disclosure.

FIG. 4 shows a flow chart of a simulatively-touch method according to yet another some embodiments of the present disclosure.

FIG. 5 shows a flow chart of a simulatively-touch method according to yet another some embodiments of the present disclosure.

FIG. 6 shows a flow chart of a method for establishing a mapping relation according to some embodiments of the present disclosure.

FIG. 7 illustrates a schematic diagram of a target position according to some embodiments of the present disclosure.

FIG. 8 illustrates a schematic diagram of an electronic device according to some embodiments of the present disclosure.

FIG. 9 illustrates a schematic diagram of a touch control system according to some embodiments of the present disclosure.

FIG. 10 illustrates a schematic diagram of a touch component according to some embodiments of the present disclosure.

FIG. 11 illustrates a schematic diagram of a torn h control system according to another some embodiments of the present disclosure.

FIG. 12 illustrates a schematic diagram of a device having a storage function according to some embodiments of the present disclosure.

### DETAILED DESCRIPTION

The disclosure will clearly and completely be described in detail with reference to the accompanying drawings and examples.

According to some embodiments of the present disclosure, a simulatively-touch method is provided for simulating a touch on a target device. The method may include the following operations. An application is installed in the target device for acquiring a specific authority. After being installed, the application receives a non-touch event from a gamepad and converts the non-touch event into a touch event based on the acquired authority. The touch event is then transmitted to the target device. The target device determines a “touched” position of its touch component by parsing the touch event. In this way, a simulative touch on the touch component of the target device can be achieved.

As afore-mentioned, the simulatively-touch method relies on the application installed on the target device, which requires that the application acquires a specific authority to perform event genre conversion (from the non-touch event into the touch event) in the target device for converting a non-touch event generated by the gamepad into a touch event so as to simulate a touch on the touch component of the target device. That is, the application must be installed in the target device and the specific authority must be acquired, which leads to complexity of implementation of the above simulatively-touch method, and brings inconvenience of use of the gamepad involved in the above simulatively-touch method.

Accordingly, other embodiments of the present disclosure provide a simulatively-touch method to simplify the implementation of simulative touch on a target device in order to improve the convenience of use of the gamepad. The method will be described below.

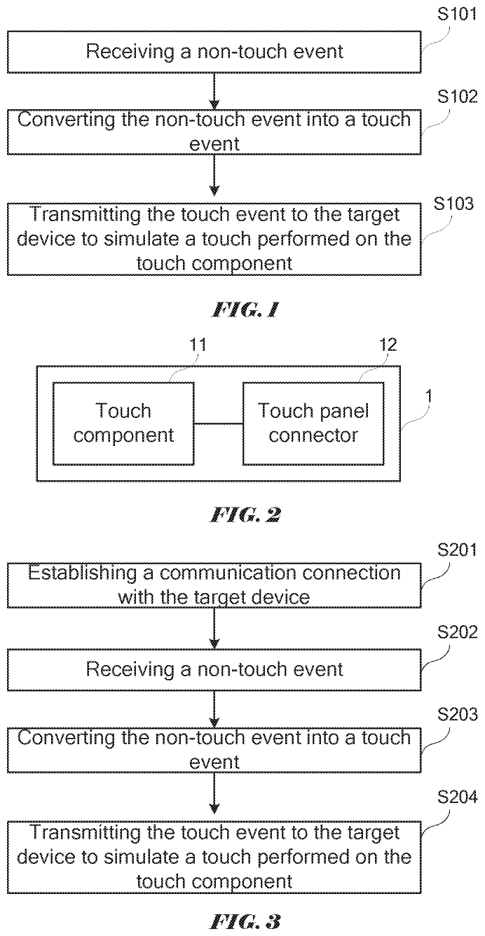

FIG. 1 shows a flow chart of a simulatively-touch method according to some embodiments of the present disclosure, and FIG. 2 shows a schematic diagram of a target device according to some embodiments of the present disclosure.

The simulatively-touch method of the present embodiment is used for simulating a touch performed on a target device 1. The target device 1 may include a touch component 11 and a touch panel connector 12. The touch component 11 may either be originally included in the target device 1 or be an external device. In some embodiments, the target device 1 may include a build-in touch component 11 and an external touch component 11 at the same time. Simulating a touch on the target device 1 means simulating a touch on the touch component 11 of the target device 1. The touch component 11 may be a touch control screen and/or touch control panel. A touch control screen is a digital converter integrated with a display, and a touch control panel is a digital converter which is not integrated with a display. The touch component 11 of the target device 1 is configured for presenting a human-machine interface to a user. The user may input a series of control commands to the target device 1 by manipulating the touch component 11 so as to drive the target device 1 to perform corresponding operations. In this way, the user may acquire contents that the user wants.

For example, the touch control screen of the target device may present a gaming interface to the user. A portion of the touch control screen may present corresponding virtual buttons of the game. The user may input control commands to the target device by touching the portion of the touch control screen which presents virtual buttons so as to drive contents of the game to develop as the user's wish. For example, the user may touch a portion of the touch control screen which presents the “Attack” virtual button to drive the character in the game to perform an attack action. The simulatively-touch method of the present disclosure relates to a process simulating a user's touch performed on the touch component of the target device.

The non-touch event and the touch event of the present embodiment may both be generated by a Human Interface Device (HID). The HID is a media for interaction between human and machine. The HID may be a human-machine interface or other devices complying with the HID specification. A touch event refers to a command event generated by a device which is described as a touch component or a HID of a touch control panel (which is generated when a user may manipulate the HID). A non-touch event refers to a command event generated by a device which is described as a HID other than the touch component or the HID of the touch control panel.

It should be noted that the simulatively-touch method of the present embodiment may include, but is not limited to, the operations described in following blocks.

At S101, a non-touch event is received.

In the present embodiment, a non-touch event generated by a device which is described as a HID other than a HID of a touch control screen or a touch control panel is received. The non-touch event may be utilized to achieve a simulative touch on the touch component of the target device.

At S102, the non-touch event is converted into a touch event.

In the present embodiment, the target device may identify that its touch component is touched when the target device receives a touch event. The touch event may indicate that a portion of the touch component is touched. Thus, in order to achieve a simulative touch on the touch component of the target device, the non-touch event for simulating a touch may be converted into a corresponding touch event.

At S103, the touch event is transmitted to the target device to simulate a touch performed on the touch component.

In the present embodiment, after the non-touch event generated by the HID is converted into a touch event, the touch event may be transmitted to the target device. When receiving the touch event, the target device may determine that its touch component is touched and may identify a touch position. Thus, the simulative touch on the touch component is achieved, and the target device may be driven to perform a corresponding action and present the result to the user.

The conversion process from the non-touch event to the touch event is not performed in the target device. Correspondingly, the conversion process of event genre does not need a specific authority from the target device. Compared with the simulatively-touch method described in the precedent embodiment, the operation of acquiring the authority can be omitted, which simplifies the overall process of the simulatively-touch method, and improves the convenience of use of gaming devices which adopt the simulatively-touch method in the present embodiment.

It should be noted, the target device may include a touch panel connector. The touch panel connector may be a programming interface of the target device, and be configured for receiving the touch event from a touch control screen and/or a touch control panel. The touch panel connector is a window for the target device to connect to the touch control screen and/or the touch control panel. The touch panel connector may be originally installed in the target device when the target device is fabricated, and may meet the HID specification. In this embodiment, a terminal that transmits the touch event to the target device may describe itself as the HID of a touch control screen and/or a touch control panel. Thus, the target device may identify the terminal as the touch control screen and/or the touch control panel when the terminal is connected to the target device. When receiving the touch event, the target device recognizes by default that the touch event originates from the touch control screen and/or the touch control panel, and transmits the touch event to the touch panel connector so as to simulate a touch on the touch control screen. In the simulatively-touch method of the precedent embodiment, after the authority for converting event genre is acquired, the touch event is not transmitted through the touch panel connector of the target device, and without be described itself as a HID of the touch control screen and/or the touch control panel, the target device does not transmit the touch event through the touch panel connector when receiving the touch event. Thus, the transmission of the touch event still needs authority from the target device in its transmission path. However, according to the simulatively-touch method of the present embodiment, the touch event is transmitted through the touch panel connector without acquiring a specific authority. This equates the transmission process of a touch event generated by a build-in touch component of the target device. Thus, the implementation of the simulatively-touch method may be further simplified.

As mentioned above, the simulatively-touch method in the present disclosure can achieve a simulative touch on the touch component of the target device. The operation that the non-touch event is converted into the touch event is not performed in the target device, and the operation for event-converting does not need a specific authority from the target device. Thus, the operation of acquiring authority can be omitted, which simplifies the implementation of simulative touch control, and improves the convenience of use of gaming devices which adopt the simulatively-touch method in the present disclosure. Furthermore, since a terminal that transmits the touch event to the target device describes itself as a HID of a touch control screen and/or a touch control panel, the target device may identify the terminal as a touch control screen and/or a touch control panel such that the touch event may be transmitted in the target device through the touch panel connector without acquiring authority of the transmission path. Thus, the implementation of the simulatively-touch method may be further simplified.

FIG. 3 shows a flow chart of a simulatively-touch method according to another some embodiments of the present disclosure.

The simulatively-touch method described in this embodiment may be used to simulate a touch on a target device. The target device may be a mobile terminal (e.g., smart phone, tablet computer) equipped with a touch control screen and/or a touch control panel. The target device may include a touch component and a touch panel connector. The simulatively-touch on the target device means simulating a touch on the touch component of the target device. The touch component may be a touch control screen and/or a touch control panel. The touch component of the target device is utilized to present a human-machine interface to a user. The user may input a series of control commands to the target device by manipulating the touch component so as to drive the target device to perform corresponding tasks. In this way, the user may acquire contents he wants.

It is noted that the simulatively-touch method in the present embodiment may include, but is not limited to, the operations described in following blocks.

At S201, a communication connection is established with the target device.

In this embodiment, the communication connection with the target device may be established to build a signal transmission channel to the target device for transmitting a touch event described below to the target device. The communication connection may be of a wired-type, for example, the signal transmission channel to the target device may be established through a cable structure such as a wire. Alternatively, the communication connection may be wireless connection, i.e., the signal transmission channel to the target device may be established in the form of wireless communication.

In some embodiments, the wireless connection for the communication connection may include Bluetooth connection, WIFI connection, infrared connection, or operator network connection (e.g., 2G, 3G or 4G communication technology), which is not limited in the present disclosure.

At S202, a non-touch event is received.

In the present embodiment, a non-touch event which is generated by a HID other than a HID of a touch control screen or a touch control panel is received. The non-touch event is utilized to simulate a touch on the touch component of the target device. A signal transmission channel to the HID for transmitting signals such as the non-touch event may adopt the same communication connection as described above, which is not repeated herein.

Specifically, the non-touch event may be a mechanical button-press event, a leap motion control event, a light control event etc. The HID which generates the non-touch event may be a HID having mechanical physical buttons (e.g., buttons, joystick) such as a keyboard, a mouse, a game joystick etc., and may be configured to generate a mechanical button-press event. In another embodiment, the HID which generates the non-touch event may be a leap motion sensor, which may generate a leap motion control event by detecting actions of the wearer. In yet another embodiment, the HID which generates the non-touch event may be a light sensor, which may generate a light control event by identifying the user's action through detecting change of input/output light intensity.

At S203, the non-touch event is converted into a touch event.

In the present embodiment, the target device may identify that its touch component is touched when the target device receives a touch event. The touch event may indicate that a portion of the touch component is torched. Thus, in order to simulate a touch on the touch component of the target device, the non-touch event for simulating a touch may be converted. into a corresponding touch event.

The process in which the non-touch event is converted into a touch event may be a process in which a report descriptor of the non-touch event is modified. Specifically, the report descriptor of the non-touch event may be modified to be a report descriptor of a touch event. In this way, the non-touch event is converted into a touch event.

Below are listed several exemplary report descriptors of different events. Event genre conversion of an event may be achieved by modifying a report descriptor of the event to be a corresponding report descriptor of a target event.

For a keyboard:

Usage Page (Generic Desktop) 05 01

Usage (Keyboard) 09 06

For a mouse:

Usage Page (Generic Desktop) 05 01

Usage (Mouse) 09 02

For a HID of the touch panel connector:

0x05, 0x0d,//USAGE_PAGE (Digitizers

0x09, 0x04,//USAGE (Touch Screen)

0x05, 0x0D,//Usage Page (Digitizer)

0x09, 0x05,//Usage (Touch Pad)

The HID specification specifies that a HID must use the application set of usage declarations under USAGE_PAGE in order to ensure correct recognition of a genre of the HID. A subset of the application set may include a touch screen, a touch pad, a digitizer etc.

It can be known from the above described information, if the simulative touch on the touch component of the target device is achieved through a keyboard or a mouse, the report descriptor of a non-touch event outputted by the keyboard or the mouse is needed to be modified to be a report descriptor corresponding to a HID of a touch panel connector, and thus, the non-touch event is converted into a touch event which corresponds to the event genre of the touch panel connector. When receiving the touch event, the target device may identify the touch event as an event corresponding to the touch panel connector, which describe touch information on a portion of the touch component.

At S204: the touch event is transmitted to the target device to simulate a touch on the touch component.

In the present embodiment, after the noel-touch event generated by the HID is converted into a touch event, the touch event may be transmitted to the target device. When receiving the touch event, the target device may determine that its touch component is touched and may identify the touch position. Thus, the simulatively-touch on the touch component is achieved, and the target device may be driven to perform the corresponding action and present the result to the user.

The process that the non-touch event is converted into the touch event is not performed in the target device. Correspondingly, the converting of event genre does not need a specific authority from the target device. This can simplify the implementation of the simulatively-touch method, and may improve the convenience of use of gaming devices which adopt the simulatively-touch method in the present embodiment.

Furthermore, in this embodiment, a terminal that transmits the touch event to the target device may describe itself as a HID of a touch control screen and/or a touch control panel. Thus, the target device may identify the terminal as a touch control screen and/or a touch control panel when the terminal is connected to the target device. When receiving the touch event, the target device recognizes by default that the touch event originates from the touch control screen and/or touch control panel, and transmits the touch event to the touch panel connector so as to achieve a simulative touch on the touch control screen. The touch event is transmitted through the touch panel connector, which can be achieved without acquiring a specific authority, and equates the transmission process of a touch event generated by a build-in touch component of the target device. Thus, the implementation of the simulatively-touch method may be further simplified.

The implementation of the simulatively-touch method provided in the present disclosure can achieve a simulative touch on a touch component of a target device. The operation that the non-touch event is converted into the touch event is not performed in the target device, and this conversion operation does not need the specific authority from the target device. Thus, the operation of acquiring authority can be omitted, which simplifies the implementation of simulative touch control, and improves the convenience of use of gaming devices which adopt the simulatively-touch method in the present disclosure. Furthermore, since the terminal that transmits the touch event to the target device describes itself as a HID of a touch control screen and/or a touch control panel, the target device may identify the terminal as the touch control screen and/or the touch control panel such that the touch event may be transmitted in the target device through the touch panel connector without acquiring authority of the transmission path. Thus, the implementation of the simulatively-touch method may be further simplified.

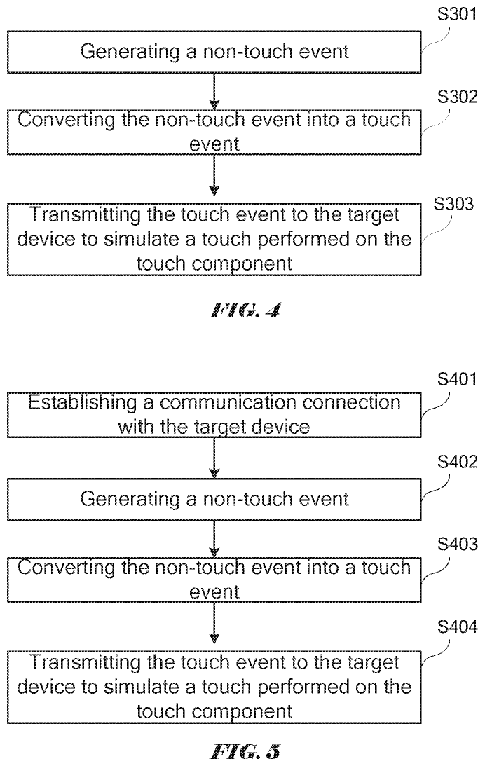

FIG. 4 shows a flow chart of a simulatively-touch method according to yet another some embodiments of the present disclosure.

The simulatively-touch method described in this embodiment may be used for simulating a touch on a target device. The target device may include a touch component and a touch panel connector. The simulative touch on the target device means simulating a touch on the touch component of the target device. The touch component may be a touch control screen and/or a touch control panel. The touch component of the target device is utilized to present a human-machine interface to a user. The user may input a series of control commands to the target device by manipulating the touch component so as to drive the target device to perform corresponding tasks. In this way, the user may acquire contents he wants.

It is noted that the simulatively-touch method in the present embodiment may include, but is not limited to, the operations described in following blocks.

At S301, a non-touch event is generated.

In the present embodiment, a HID complying with the HID specification may generate a non-touch event. The non-touch event may be utilized for simulating a touch performed on the touch component of the target device. The HID may be described as a HID other than a touch control screen or a touch control panel. For example, the HID may be a mouse, a keyboard, or a game joystick, which is not limited herein.

At S302, the non-touch event is converted into a touch event.

In the present embodiment, the target device may identify that its touch component is touched when the target device receives a touch event, The touch event may indicate that a portion of the touch component is touched. Thus, in order to simulate a touch performed on the touch component of the target device, the non-touch event for simulating the touch may be converted into a corresponding touch event.

At S303, the touch event is transmitted to the target device to simulate a touch on the touch component.

In the present embodiment, after the non-touch event generated by the HID is converted into a touch event, the touch event may be transmitted to the target device. When receiving the touch event, the target device may determine that its touch component is touched and may identify the touch position. Thus, the simulative touch on the touch component is achieved, and the target device may be driven to perform the corresponding action and present the result to the user.

The process that the non-touch event is converted into the touch event is not performed in the target device. Correspondingly, the converting of event genre does not need a specific authority from the target device. Furthermore, in this embodiment, the terminal (i.e. a HID which generates the non-touch event) that transmits the touch event to the target device may describe itself as a HID of a touch control screen and/or a touch control panel. Thus, the target device may identify the terminal as a touch control screen and/or a touch control panel when the terminal is connected to the target device. When receiving the touch event, the target device recognizes by default that the touch event originates from the touch control screen and/or touch control panel, and transmits the touch event to the touch panel connector so as to achieve a simulative touch on the touch control screen. The touch event is transmitted through the touch panel connector, which can be achieved without acquiring a specific authority, and equates the transmission process of a touch event generated by a build-in touch component of the target device. Thus, the implementation of the simulatively-touch method may be further simplified.

The implementation of the simulatively-touch method provided in the present disclosure can achieve a simulative touch on a touch component of a target device. The operation that the non-touch event is converted into the touch event is not performed in the target device, and this conversion operation does not need the specific authority from the target device. Thus, the operation of acquiring authority can be omitted, which simplifies the implementation of simulative touch control, and improves the convenience of use of gaming devices which adopt the simulatively-touch method in the present disclosure. Furthermore, since the terminal that transmits the touch event to the target device describes itself as a HID of a touch control screen and/or a touch control panel, the target device may identify the terminal as a touch control screen and/or a touch control panel such that the touch event may be transmitted in the target device through the touch panel connector without acquiring authority of the transmission path. Thus, the implementation of the simulatively-touch method may be further simplified.

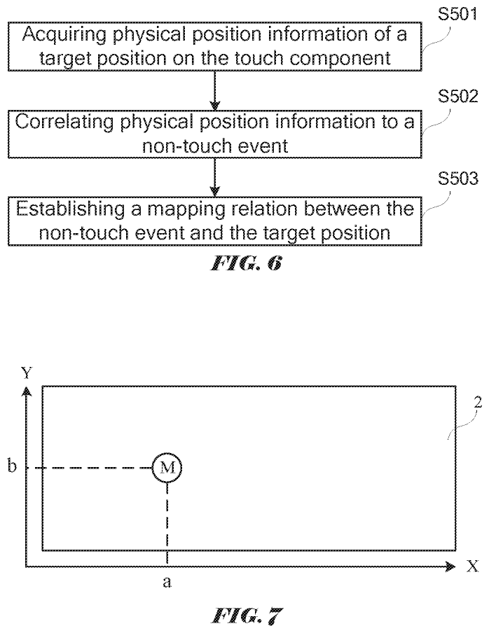

FIG. 5 shows a flow chart of a simulatively-touch method according to yet another some embodiments of the present disclosure.

The simulatively-touch method described in this embodiment may be used for simulating a touch performed on a target device. The target device may include a touch component and a touch panel connector. The simulative touch on the target device means simulating a touch on the touch component of the target device. The touch component may be a touch control screen and/or a touch control panel. The touch component of the target device is utilized to present a human-machine interface to a user. The user may input a series of control commands to the target device by manipulating the touch component so as to drive the target device to perform corresponding tasks. In this way, the user may acquire contents he wants.

It is noted that the simulatively-touch method in the present embodiment may include but is not limited to, the operations described in following blocks.

At S401, a communication connection is established with the target device.

In this embodiment, the communication connection with the target device may be established to build a signal transmission channel to the target device for transmitting a touch event described below to the target device. The communication connection may be of a wired-type, for example, the signal transmission channel to the target device may be established through a cable structure such as a wire. Alternatively, the communication connection may be wireless connection, i.e., the signal transmission channel to the target device may be established in the form of wireless communication.

The wireless communication in the present embodiment may be the same as that described in precedent embodiments, which is not repeated herein.

At S402, a non-touch event is generated.

In the present embodiment, a HID complying with the HID specification may generate a non-touch event. The non-touch event may be utilized for simulating a touch on the touch component of the target device. The HID may be described as a HID other than a touch control screen or a touch control panel. For example, the HID may be a mouse, keyboard, or joystick, which is not limited herein.

At S403, the non-touch event is converted into a touch event.

In the present embodiment, the target device may identify that its touch component is touched when the target device receives a touch event. The touch event may indicate that a portion of the touch component is touched. Thus, in order to simulate a touch on the touch component of the target device, the non-touch event for simulating the touch may be converted into a corresponding touch event.

The specific process for converting a non-touch event into a touch event has been described in aforesaid embodiments, which is not repeated herein.

At S404, the touch event is transmitted to the target device to simulate a touch on the touch component.

In the present embodiment, after the non-touch event generated by the HID is converted into a touch event, the touch event may be transmitted to the target device. When receiving the touch event, the target device may determine that its touch component is touched and may identify the touch position. Thus, the simulative touch on the touch component is achieved, and the target device may be driven to perform the corresponding action and present the result to the user.

The process that the non-touch event is converted into the touch event is not performed in the target device. Correspondingly, the converting of event genre does not need a specific authority from the target device. This can simplify the implementation of the simulatively-touch method, and may improve the convenience of use of gaming devices which adopt the simulatively-touch method in the present embodiment.

Furthermore, in this embodiment, the terminal that transmits the touch event to the target device may describe itself as a HID of a touch control screen and/or a touch control panel. Thus, the target device may identify the terminal as a touch control screen and/or a touch control panel when the terminal is connected to the target device. When receiving the touch event, the target device recognizes by default that the touch event originates from the touch control screen and/or touch control panel, and transmits the touch event to the touch panel connector so as to achieve a simulative touch on the touch control screen. The touch event is transmitted through the touch panel connector, which can be achieved without acquiring a specific authority, and equates the transmission process of a touch event generated by a build-in touch component of the target device. Thus, the implementation of the simulatively-touch method may be further simplified.

The implementation of the simulatively-touch method provided in the present disclosure can achieve a simulative touch on a touch component of a target device. The operation that the non-touch event is converted into the touch event is not performed in the target device, and this event converting operation does not need the specific authority from the target device. Thus, the operation of acquiring authority can be omitted, which simplifies the implementation of simulative touch control, and improves the convenience of use of gaming devices which adopt the method for simulative touch in the present disclosure. Furthermore, since the terminal that transmits the touch event to the target device describes itself as a HID of a touch control screen and/or a touch control panel, the target device may identify the terminal as a touch control screen and/or a touch control panel such that the touch event may be transmitted in the target device through the touch panel connector without acquiring authority of the transmission path. Thus, the implementation of the simulatively-touch method may be further simplified.

FIG. 6 is a flow chart of a method for establishing a mapping relation according to some embodiments of the present disclosure.

It should be noted, a touch event is an event generally generated for describing that a target position on the touch component of the target device is touched. However, a touch event described in the present disclosure is actually not generated by touching the touch component. The touch event may carry the physical-position information (e.g., position coordinates) of the target position on the touch component.

Before the simulatively-touch method described in aforesaid embodiments is performed, mapping relations between target positions and non-touch events may be established. In this implementation, the generation of a non-touch event may lead to the simulative touch on a target position of the touch component. Operations of the method will be described in the blocks below

At S501, physical-position information of a target position on the touch component is acquired.

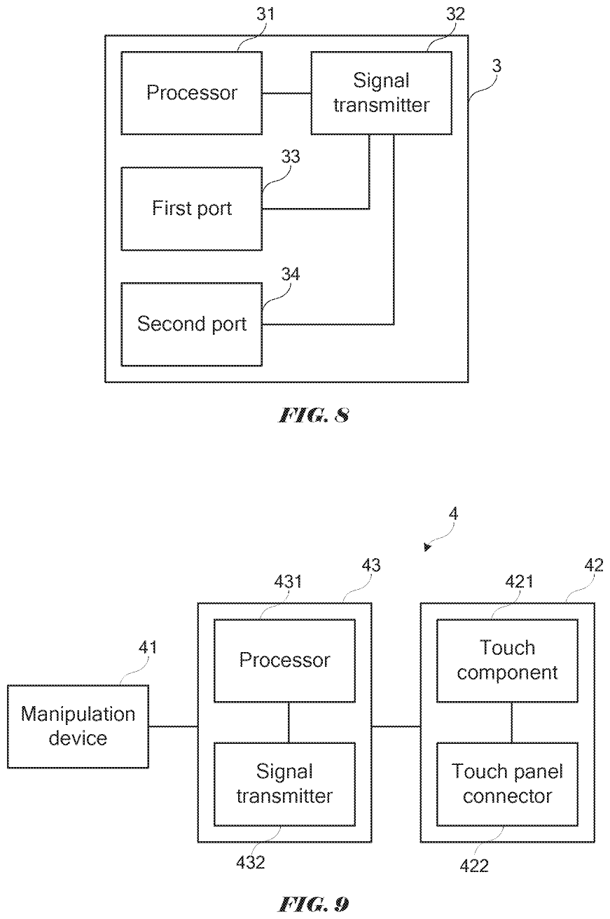

In the present embodiment, the touch component may be a touch control screen or a touch control panel. An ordinary touch component usually has a flat configuration which can define two axes not parallel to each other. In order to easily describe physical-position information of each position on the touch component 2, two perpendicular coordinate axes X and Y may be utilized to describe the specific position of a target position M on the touch component 2 in the present embodiment. Thus, acquiring physical-position information of the target position M on the touch component 2 equates acquiring the coordinate value (a, b) of the target position M with respect to the coordinate axes X and Y, as shown in FIG. 7.

At S502, physical-position information is correlated to a non-touch event.

In the present embodiment, since the target position on the touch component where a simulative touch happens is known, and the generation of the non-touch event may lead to the simulative touch of the target position on the touch component, it is required that the non-touch event may be correlated to the physical-position information of the target position. In other words, a relation between the non-touch event and the physical-position information of the target position may be established. Accordingly, when the non-touch event is generated, the simulative touch on the target position which corresponds to the non-touch event of the touch component may be simulated.

At S503, a mapping relation between the non-touch event and the target position is established.

In the present embodiment, it is required that the physical-position information of the target position is correlated to the non-touch event, that is, a mapping relation between the non-touch event and the target position may be established. In this implementation, the non-touch event is bonded with the target position. In the implementation of the simulatively-touch method described in aforesaid embodiments, the non-touch event may describe a simulative touch on the corresponding target position.

In order to achieve the above implementation, when the non-touch event is converted into a touch event (which has been described in aforesaid embodiments), the physical-position information of the target position (i.e., coordinate values of the target position with respect to corresponding coordinate axes X and Y) on the touch component may be included in the touch event. In this implementation, when receiving the touch event, the target device may identify the specific target position on the touch component on which a simulative touch.

In some embodiments, a target position may be correlated to a non-touch event, a component which generates the non-touch event, or a touch event converted from the non-touch event, which is not limited in the present disclosure.

Further, mapping relations between non-touch events and target positions may be adjusted. When a corresponding target position of a simulative touch on the touch component of a non-touch event is changed, a new mapping relation between the non-touch event and the new target position may be established.

It should be noted, the simulatively-touch method of the present disclosure may be suitable for various kinds of non-touch events, which may come from different HIDs or from different manipulation ends (e.g., different buttons on a keyboard) of a same HID. In this circumstance, mapping relations between different kinds of non-touch events and corresponding target positions on the touch component need to be established. The mapping relations between different kinds of non-touch events and corresponding target positions on the touch component may constitute a set of mappings.

It is appreciated that, when corresponding target positions on the touch component of at least some of non-touch events are modified, a different set of mappings may be acquired. That is, by adjusting the corresponding target positions of at least some of non-touch events to make the at least some of non-touch events be mapped to new portions of the touch component, simulative touches on these new portions may be achieved. In this implementation, different mapping schemes may be established for different application scenarios and manipulations. Thus, renew of the overall mapping scheme caused by change of specific application scenario or manipulation, which may degrade the user experience, can be avoided.

In some embodiments, establishment and record of the above mapping relations and/or mapping schemes may be carried out by an application installed on the target device. The application installed on the target device may record the mapping relations and the mapping schemes between non-touch events and corresponding target positions. When a non-touch event is converted into a touch event, the application may add the physical-position information of a corresponding target position into the touch event. In some embodiments, when detecting a current application scenario and manipulation, the application may select a suitable mapping scheme. In other embodiments, the user may select a required mapping scheme through the application.

Let's take an application scenario where a gamepad adopts the above simulatively-touch method to achieve simulative touch control on the target device as example. The gamepad is usually configured with a joystick and several buttons for outputting non-touch events. Each of the joystick and buttons corresponds to a target position on a touch control screen of a target device. Mapping relations between the joystick and buttons and their corresponding target positions may constitute a mapping scheme. For different games on the target device, the target positions on which simulative touches of the joystick and buttons of the gamepad occur may be different, and therefore the mapping relations need to be adjusted. Different mapping schemes may be switched for different manipulation targets (e.g., games on the target device), which may allow rapid adjustment of the whole mapping relations of the joystick and buttons on the gamepad, and may allow a user to rapidly find a suitable mapping scheme for the user to experience the game.

The establishment and record of the above described mapping relations and/or mapping schemes are not limited to be achieved by an application installed in the target device. In other embodiments, the executor for establishing and recording the above mapping relations and/or mapping schemes may be an independent device communicatively connected with the target device. The independent device can process the touch event (e.g., adding the physical-position information of the corresponding target position in the touch event) and then transmit the processed touch event to the target device so as to achieve the simulative touch.

An exemplary application scenario will be introduced below for describing the simulatively-touch method of the present disclosure, which will not limit the application scenarios of the simulatively-touch method provided by the present disclosure.

The product that applies the simulatively-touch method of the present disclosure in this application scenario may be a gamepad. The gamepad itself and its physical buttons comply with the HID specification, and can be used for simulative touch control of a connected mobile terminal (e.g., smart phone). Mapping relations between physical buttons of the gamepad and target positions of a touch control screen of the mobile terminal may be pre-established. The process for simulative touch control may substantially include the following operations.

1. The gamepad is connected to the mobile terminal, and the gamepad describes itself as a HID of a touch control screen and/or a touch control panel.

2. A user uses the gamepad and manipulates one of its physical buttons to generate a non-touch event.

3. The gamepad converts the non-touch event into a touch event, and transmits the touch event to the mobile terminal.

4. The mobile terminal receives the touch event from the gamepad, and identifies the gamepad as a touch control screen and/or a touch control panel. Thus, the touch event is transmitted to a touch panel connector in the mobile terminal, and then the touch event may be transmitted to a processing component of the mobile terminal through the touch panel connector. Even if the touch component is not actually touched, the processing component may determine that the touch component is touched and identify the touch position so as to achieve the simulative touch.

In order to improve the convenience of current gaming devices, the present disclosure further provides an electronic device which is used for simulating a touch on a target device. The target device may include a touch control screen and a touch panel connector. The electronic device may include a processor and a signal transmitter coupled together. The signal transmitter may be configured for receiving a non-touch event and transmitting to the processor. The processor is configured for receiving the non-touch event from the signal transmitter, converting the non-touch event into a touch event, and feeding the touch event back to the signal transmitter. The signal transmitter may be further configured for receiving the touch event from the processor, and transmitting the touch event to the target device to simulate a touch on the touch control screen. The target device may transmit the touch event to the touch panel connector. The electronic device may describe itself as a HID of a touch control screen or a touch control panel for transmitting touch event to the touch panel connector. Details will be described below.

FIG. 8 shows a structural diagram of an electronic device according to some embodiments of the present disclosure.

The electronic device 3 in the present embodiment may function as a media for event conversion, and be used for achieving the simulatively-touch method described in aforesaid embodiments. The electronic device may be, for example, a keyboard and a mouse converter, which can convert a non-touch event into a corresponding touch event so as to simulate a touch on a touch component of the target device. The detailed scheme will be described below.

In the present embodiment, the electronic device 3 may be used for simulating a touch performed on the target device. The target device may include a touch component and a touch panel connector. Technical solutions related to the touch component and the touch panel connector have been explained in above embodiments and will not be repeated herein.

In the present embodiment, the electronic device 3 may include a processor and a signal transmitter 32 coupled together. The processor 31 and the signal transmitter 32 may be coupled via, for example, a circuit wire to transmit electrical signals.

Specifically, the simulatively-touch method as described in aforesaid embodiments may be performed by the electronic device 3 in following operations. The signal transmitter 32 may be configured to receive a non-touch event and transmit the non-touch event to the processor 31. The processor 31 may be configured to receive the non-touch event from the signal transmitter 32, convert the non-touch event into a touch event, and feed the touch event back to the signal transmitter 32. The signal transmitter 32 may further be configured to receive the touch event from the processor 31, and transmit the touch event to the target device to simulate a touch on the touch component. The touch event is transmitted to the touch panel connector in the target device.

The process that the non-touch event is converted into the touch event is not performed in the electronic device 3, instead of the target device. Correspondingly, the converting of event genre does not need a specific authority from the target device. This can simplify the implementation of the simulatively-touch method, and may improve the convenience of use of gaming devices of the electronic device 3 which adopt the simulatively-touch method provided by the present embodiment.

Furthermore, in this embodiment, the electronic device 3 may describe itself as a HID of a touch control screen and/or a touch control panel. Thus, the target device may identify the electronic device as a touch control screen and/or a touch control panel when the electronic device is connected to the target device. When receiving the touch event, the target device recognizes by default that the touch event originates from the touch control screen and/or touch control panel, and transmits the touch event to the touch panel connector so as to achieve a simulative touch on the touch control screen. The touch event is transmitted through the touch panel connector, which can be achieved without acquiring a specific authority, and equates the transmission process of a touch event generated by a build-in touch component of the target device. Thus, the implementation of the simulatively-touch method may be further simplified.

Further, the electronic device 3 may further include a first port 33 coupled to the signal transmitter 32. The first port 33 may be connected to a manipulation device for receiving a non-touch event generated by the manipulation device and then transmitting the non-touch event to the signal transmitter 32. The signal transmitter 32 may then transmit the non-touch event to the processor 31 so as to perform other tasks such as event genre conversion.

In some embodiments, the manipulation device may also be a HID complying with the HID specification, and be utilized for generating a non-touch event. The manipulation device may be configured with physical buttons(including buttons, joystick etc.), for example, it may be a component or a part of a gamepad with physical buttons. In other embodiments, the manipulation device may be at least one of a mouse, a keyboard, a game joystick, a leap motion sensor and a light sensor, which complies with the HID specification and is utilized for simulating a touch on the target device.

The electronic device 3 may further include a second port 34 coupled to the signal transmitter 32. The second port 34 may be utilized to be connected to the target device so as to transmit the touch event to the target device. The target device may transmit the touch event to its processing component for analysis through its touch panel connector, so as to achieve simulative touch on the touch component of the target device.

Further, there may be multiple manipulation devices which can output non-touch events to the electronic device 3. Correspondingly, the electronic device 3 may include multiple first ports 33, and each first port 33 is set for a respective manipulation device and configured to receive non-touch events from the respective manipulation device. In some embodiments, the first port 33 may be a USB interface. The electronic device 3 may be connected to a manipulation device through a data cable for signal exchange.

Similarly, there may be multiple target devices under control of the electronic device 3. Correspondingly, the electronic device 3 may include multiple second ports 34, and each second port 34 is set for a respective target device and configured to transmit a touch event which is acquired through event genre conversion to the respective target device. In some embodiments, the second port 34 may be a USB interface. The electronic device 3 may be connected to a target device through a data cable for signal exchange.

According to the electronic device provided by the present disclosure, the operation that the non-touch event is converted into the touch event is not performed in the target device but in the electronic device, and thus the event converting operation does not need a specific authority from the target device. Thus, the operation of acquiring authority can be omitted, which simplifies the implementation of simulative touch control, and improves the convenience of use of gaming devices with the electronic device. Furthermore, since the electronic device describes itself as a HID of a touch control screen and/or a touch control panel, the target device may identify the electronic device as a touch control screen and/or a touch control panel such that the touch event may be transmitted in the target device through the touch panel connector without acquiring authority of the transmission path. Thus, the implementation of the simulatively-touch method may be further simplified.

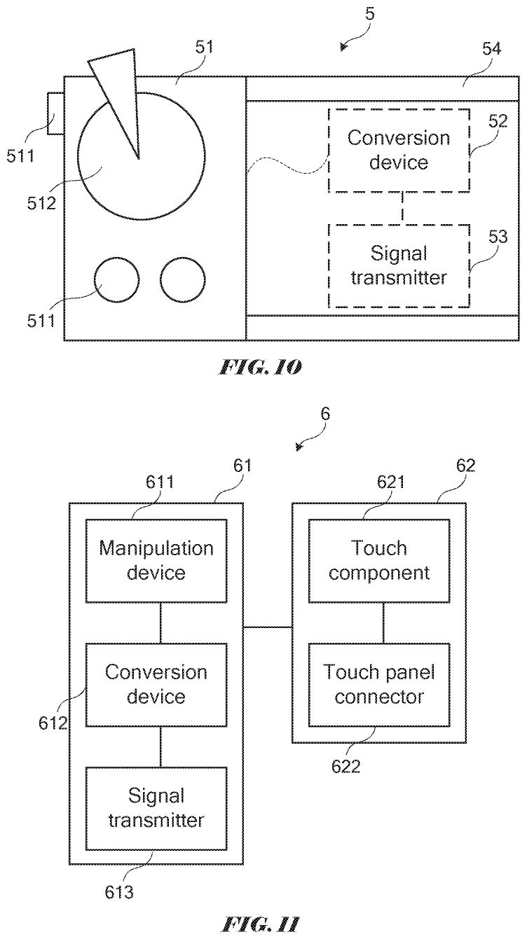

FIG. 9 shows a schematic diagram of a touch control system according to some embodiments of the present disclosure.

A touch control system 4 is provided by the present embodiment to achieve the simulatively-touch method described in aforesaid embodiments. The touch control system 4 may include a manipulation device 41, a target device 42, and an electronic device 43. The manipulation device 41 and the target device 42 may be connected to the electronic device 43, respectively. The electronic device 43 may be used for simulative touch control of the target device 42. The target device 42 may include a touch component 421 and a touch panel connector 422. The electronic device 43 may include a processor 431 and a signal transmitter 432. The processor 431 may be coupled to the signal transmitter 432. The electronic device 43 may be the electronic device described in aforesaid embodiment, which will not be repeated herein.

The manipulation device 41 may be configured to generate a non-touch event. The signal transmitter 432 of the electronic device 43 may be configured to receive the non-touch event, and transmit the non-touch event to the processor 431 of the electronic device 43. The processor 431 may be configured to receive the non-touch event from the signal transmitter 432, convert the non-touch event into a touch event, and feed the touch event back to the signal transmitter 432. The signal transmitter 432 may further be configured to receive the touch event from the processor 431, and transmit the touch event to the target device 42 to achieve a simulative touch on the touch component 421. The touch event is transmitted to the touch panel connector 422 in target device 42.

A connection between the manipulation device 41 and the electronic device 43 may adopt a wired-form (i.e., a connection through a data cable) as described in aforesaid. embodiments, or alternatively be wireless connection. Similarly, a connection between the target device 42 and the electronic device 43 may adopt a wired-form as described in aforesaid embodiments, or alternatively be wireless connection.

In some embodiments, the wireless connection may include Bluetooth connection, WIFI connection, infrared connection, operator network connection (e.g., 2G, 3G or 4G communication technology), which is not limited herein.

In order to improve the convenience of current gaming devices, the present disclosure further provides a touch control assembly which is used for simulating a touch on a target device. The target device may include a touch component and a touch panel connector. The touch control assembly may include a manipulation device, a conversion device and a signal transmitter. The manipulation device and the signal transmitter may be connected to the conversion device, respectively. The manipulation device may be configured with physical buttons for generating a non-touch event. The manipulation device may be configured to transmit the non-touch event to the conversion device. The conversion device may be configured to receive the non-touch event, convert the non-touch event into a touch event, and transmit the touch event to the signal transmitter. The signal transmitter may be configured to receive the touch event, and transmit the touch event to the target device to simulate a touch on the touch component. The touch event is transmitted to the touch panel connector in the target device, and the touch control assembly may be described as a HID of a touch control screen or a touch control panel configured for transmitting the touch event to the touch panel connector. Details will be described below.

FIG. 10 illustrates a schematic diagram of a touch control assembly according to some embodiments of the present disclosure.

The touch control assembly 5 of the present embodiment may be configured to generate a non-touch event and function as a media for event genre conversion so as to achieve the simulatively-touch method described in aforesaid embodiments. The detail will be described below.

In the present embodiment, the touch control assembly 5 may be used for simulating a touch on a target device. The target device may include a touch component and a touch panel connector. Technical solutions of the touch component and the touch panel connector have been explained in aforesaid embodiments, and will not be repeated herein.

In the present embodiment, the touch control assembly 5 may include a manipulation device 51, a conversion device 52 and a signal transmitter 53. The manipulation device 51 and the signal transmitter 53 may be connected to the conversion device 52, respectively. Specifically, the simulatively-touch method as described in aforesaid embodiments may be performed by the touch control assembly 5 in following operations.

The manipulation device 51 may be configured to generate a non-touch event, and transmit the non-touch event to the conversion device 52. The conversion device 52 may be configured to receive the non-touch event, convert the non-touch event into a touch event, and transmit the touch event to the signal transmitter 53. The signal transmitter 53 may be configured to receive the touch event and transmit the touch event to the target device to simulate a touch on the touch component. The touch event is transmitted to the touch panel connector in the target device, and the touch control assembly 5 may be described as a HID of a touch control screen or a touch control panel for transmitting the touch event to the touch panel connector.

Since the operation that the non-touch event is converted into the touch event is not performed in the target device but in the touch control assembly 5, this event conversion operation does not need a specific authority from the target device. Thus, the implementation of simulatively-touch method may be simplified, and the convenience of use of the touch control assembly 5 may be improved.

Furthermore, in this embodiment, the touch control assembly 5 may describe itself as a HID of a touch control screen and/or a touch control panel. Thus, the target device may identify the terminal as a touch control screen and/or a touch control panel when the terminal is connected to the target device. When receiving the touch event, the target device recognizes by default that the touch event originates from the touch control screen and/or touch control panel, and transmits the touch event to the touch panel connector so as to achieve a simulative touch on the touch control screen. The touch event is transmitted through the touch panel connector, which can be achieved without acquiring a specific authority, and equates the transmission process of a touch event generated by a build-in touch component of the target device. Thus, the implementation of the simulatively-touch method may be further simplified.

The touch control assembly 5 of the present embodiment may be a gamepad. A manipulation device 51 may be configured with physical buttons such as buttons 511 and a joystick 512, which can be used to generate non-touch events. When a user manipulates the physical buttons on the manipulation device 51, the manipulation device 51 may be driven to generate corresponding non-touch events so as to simulate a touch on the touch component of the target device.

In other embodiments of the present disclosure, the manipulation device 51 may be at least one of a keyboard, a joystick, a motion leap sensor and a light sensor, which comply with the HID specification, and thus the manipulation device 51 is different from a gamepad.

Further, the touch control assembly 5 may further include a connection device 54. The connection device 54, the manipulation device 51, the conversion device 52 and the signal transmitter 53 may be an integrated structure. The connection device 54 may be configured to assemble and fix the target device. When a user uses the touch control assembly 5 to control the target device, the touch control assembly 5 and the target device may be assembled as an integrated structure. In this implementation, the user may easily hold the touch control assembly 5 and/or the target device, which may improve convenience of use of the touch control assembly 5 and improve the user experience.

Further, the physical buttons of the manipulation device 51 may include at least one button 511 and a joystick 512. The joystick 512 and at least some of buttons 511 may be set on the top surface of the manipulation device 51 for being manipulated by the user's two thumbs. At least some of buttons 511 may be set on a side surface of the manipulation device 51 for being manipulated by the user's two forefingers.

It should be noted, each of the buttons 511 and the joystick 512 of the manipulation device 51 corresponds to a type of non-touch event, that is, to a simulative touch on a respective target position of the touch component of the target device. In other embodiments, one button 511 or the joystick 512 may correspond to several target positions, or one target position may correspond to several buttons 511 and/or the joystick 512, which is not limited in the present disclosure.

In other embodiments of the present disclosure, the manipulation device, the conversion device, and the signal transmitter may be independent from each other. Connections between the manipulation device and the conversion device and between the signal transmitter and the conversion device may be wired or wireless connection. The wireless connection may include Bluetooth connection, WIFI connection, infrared connection, operator network connection etc.

According to the touch control assembly provided by the present disclosure, the operation that the non-touch event is converted into the touch event is not performed in the target device but in the touch control assembly, and this event converting operation does not need a specific authority from the target device. Thus, the operation of acquiring authority can be omitted, which simplifies the implementation of simulatively-touch method, and improves the convenience of use of the touch control assembly. Furthermore, since the touch control assembly describes itself as a HID of a touch control screen and/or a touch control panel, the target device may identify the touch control assembly as a touch control screen and/or a touch control panel such that the touch event may be transmitted in the target device through the touch panel connector without acquiring authority of the transmission path. Thus, the implementation of the simulatively-touch method may be further simplified.

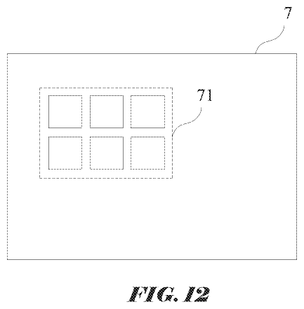

FIG. 11 is a schematic diagram of a touch control system according to another some embodiments of the present disclosure.

In the present embodiment, the touch control system 6 may include a touch control assembly 61 and a target device 62 connected together. The touch control assembly 61 may be used for simulating a touch on the target device 62. The target device 62 may include a touch component 621 and a touch panel connector 622. The touch control assembly 61 may include a manipulation device 611, a conversion device 612, and a signal transmitter 613. The manipulation device 611 and the signal transmitter 613 may be connected to the conversion device 612, respectively.

Specifically, the simulatively-touch method as described in aforesaid embodiments may be performed by the touch control system 6 in following operations. The manipulation device 611 may be configured with a physical button 6111 for generating a non-touch event. The manipulation device 611 may be configured to transmit the non-touch event to the conversion device 612. The conversion device 612 may be configured to receive the non-touch event, convert the non-touch event into a touch event, and transmit the touch event to the signal transmitter 613. The signal transmitter 613 may be configured to receive the touch event and transmit the touch event to the target device 62 to simulate a touch on the touch component 621. The touch event is transmitted to the touch panel connector 622 in the target device 62, and the touch control assembly 61 may be described as a HID of a touch control screen or a touch control panel for transmitting the touch event to the touch panel connector 622.

FIG. 12 shows a schematic diagram of a device having storage function according to some embodiments of the present disclosure.

In the present embodiment, the device 7 having a storage function may include instruction data 71, which may be executed to perform the simulatively-touch method as described in aforesaid embodiments. The method will not be repeated herein.

In the several implementations provided in the present disclosure, it should be understood that the disclosed system, apparatus, and method may be implemented in other manners. For example, the described apparatus embodiment is merely exemplary. For example, division of the module or unit is merely logical function division and may be other division in actual implementation. For example, a plurality of units or components may be combined or integrated into another system, or some features may be ignored or not performed. In addition, the displayed or discussed mutual couplings, direct couplings, or communication connections may be implemented by using some interfaces. The indirect couplings or communication connections between apparatuses or units may be implemented in electronic, mechanical, or other forms.

The units described as separate parts may or may not be physically separate, and parts displayed as units may or may not be physical units. That is, the units may be located in one position, or may be distributed on a plurality of network units. Some or all of the units may be selected according to actual needs to achieve the objectives of the solutions of the implementation manners.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the prior art, or all or some of the technical solutions may be implemented in the form of a software product. The software product is stored in a storage medium and includes several instructions for instructing a computer device (which may be a personal computer, a server, a network device, or the like) or a processor to perform all or some of the steps of the methods described in the embodiments of the present disclosure. The foregoing storage medium includes: any medium that can store program code, such as a USB flash drive, a portable hard disk, a read-only memory (ROM), a random-access memory (RAM), a magnetic disk, or an optical disc.

It should be noted that, the above are merely embodiments of the present disclosure without limiting the scope of the present disclosure accordingly. Equivalent structures or flows made according to the specification and the drawings of the present disclosure, or direct or indirect application in other arts shall fall into the protection scope of the present disclosure.

What is claimed is:

1. A simulatively-touch method, for simulating a touch on a target device comprising a touch component and a touch panel connector, comprising:
generating a non-touch event;
converting the non-touch event into a touch event; and
transmitting the touch event to the target device to simulate a touch performed on the touch component, wherein the touch event is transmitted to the touch panel connector in the target device.

2. The method of claim 1, wherein the converting the non-touch event into the touch event comprises:
modifying a report descriptor of the non-touch event to convert the non-touch event into the touch event;
wherein the modifying the report descriptor of the non-touch event comprises:
modifying the report descriptor of the non-touch event to be a report descriptor of the touch event.

3. The method of claim I, wherein the touch event is configured for indicating an event of a target position of the touch component being touched, and carrying a physical-position information of the target position on the touch component.

4. The method of claim 3, before the generating the non-touch event, further comprising:
acquiring the physical-position information of the target position on the touch component;
correlating the physical-position information to the non-touch event so as to establish a mapping relation between the non-touch event and the target position;
wherein the converting the non-touch event into the touch event further comprises:
adding the physical-position information of the target position on the touch component into the touch event.

5. The method of claim 4, further comprising:
determining a plurality of non-touch events;
establishing a mapping relation between each of the plurality of non-touch events and a respective target position on the touch component such that a set of mappings is formed.

6. The method of claim 5, further comprising:
modifying target positions on the touch component corresponding to at least some of the plurality of non-touch events such that another set of mappings is formed.

7. The method of claim 1, wherein the non-touch event comprises a mechanical key-press event, a leap motion control event, and a light control event.

8. The method of claim 1, before the receiving the non-touch event, further comprising:
establishing a communication connection with the target device;
wherein the communication connection is performed by a wired-type communication which establishes signal transmission channels to the target device via a cable; or
wherein the communication connection is performed by a wireless communication that comprises Bluetooth connection, WIFI connection, infrared connection, or Operator Network connection.

9. A touch control assembly for simulating a touch on a target device comprising a touch component and a touch panel connector, comprising a manipulation device, a conversion device, and a signal transmitter, the manipulation device and the signal transmitter being coupled to the conversion device,
the manipulation device being configured for generating a non-touch event and transmitting the non-touch event to the conversion device;
the conversion device being configured for receiving the non-touch event, converting the non-touch event into a touch event, and transmitting the touch event to the signal transmitter;
the signal transmitter being configured for receiving the touch event from the processor, and transmitting the touch event to the target device so as to simulate a touch performed on the touch component;
wherein the touch event is transmitted to the touch panel connector in the target device, and the touch control assembly is described as a human interface device (HID) of a touch control screen or a touch control panel for transmitting the touch event to the touch panel connector.

10. The touch control assembly of claim 9, wherein the manipulation device comprises a physical button for generating the non-touch event; or
the manipulation device is at least one of a mouse, a keyboard, a game joystick, a leap motion sensor, and a light sensor.

11. The touch control assembly of claim 9, wherein the manipulation device, the conversion device, and the signal transmitter are in an integrated structure.

12. The touch control assembly of claim 11, further comprising a connection device, wherein the connection device, the manipulation device, the conversion device, and the signal transmitter are in an integrated structure, and the connection device is configured for assembling and fixing the target device.

13. The touch control assembly of claim 12, wherein the touch control assembly is a gamepad.

14. The touch control assembly of claim 9, wherein the manipulation device, the conversion device, and the signal transmitter are independent from each other;
a connection between the manipulation device and the conversion device and a connection between the signal transmitter and the conversion device are wired connections or wireless connections.

15. The touch control assembly of claim 14, wherein the wireless connections comprise Bluetooth connection, WIFI connection, infrared connection, and Operator Network connection.

16. The touch control assembly of claim 9, wherein the physical button comprises at least one button and a joystick each of which corresponds one non-touch event.

17. The touch control assembly of claim 16, wherein the joystick and at least some of the at least one button are arranged in a top surface of the manipulation device.

18. The touch control assembly of claim 16, wherein at least some of the at least one button are arranged in a side surface of the manipulation device.

19. A touch control system, comprising a touch control assembly and a target device connected to the touch control assembly, the touch control assembly being configured for simulate a touch on the target device comprising a touch component and a touch panel connector, the touch control assembly comprising a manipulation device, a conversion device, and a signal transmitter, and the manipulation device and the signal transmitter being connected to the conversion device, respectively,
the manipulation device comprising a physical button configured for generating a non-touch event and configured for transmitting the non-touch event to the conversion device;
the conversion device being configured for receiving the non-touch event from the signal transmitter, converting the non-touch event into a touch event, and transmitting the touch event to the signal transmitter;
the signal transmitter being configured for receiving the touch event from the processor, and transmitting the touch event to the target device so as to simulate a touch performed on the touch component;
wherein the touch event is transmitted to the touch panel connector in the target device, and the touch control assembly is described as a human interface device (HID) of a touch control screen or a touch control panel for transmitting the touch event to the touch panel connector.
